(19) United States
(12) Patent Application Publication
(10) Pub. No.: US 2015/0051982 A1
(43) Pub. Date: Feb. 19, 2015

(54) APPLICATION AND METHOD FOR CREATING AND MANAGING A DATABASE CONTAINING MAILING ADDRESSES

(71) Applicant: Joshua Latimer, Linden, MI (US)

(72) Inventor: Joshua Latimer, Linden, MI (US)

(21) Appl. No.: 14/327,390

(22) Filed: Jul. 9, 2014

Related U.S. Application Data
(60) Provisional application No. 61/844,398, filed on Jul. 9, 2013.

(51) Int. Cl. G06Q 30/02; G06F 3/0484; G06F 17/30

(52) U.S. Cl. CPC G06Q 30/0269; G06F 17/30289; G06F 3/04842; G06F 17/30424
USPC 705/14.66

(57) ABSTRACT

An apparatus and method for capturing pictures and corresponding information and storing the picture and information in an accessible database. An interface, specifically a map overlay enable one to access information in the database based on geographic preferences. From the interface, direct mailings can be sent from a remote location.

### RELATED APPLICATIONS

This application claims priority from a provisional patent application No. 61/844,398 filed on 9 Jul. 2014.

### FIELD OF THE INVENTION

This invention relates to a computer program, mobile application, and system to generate a database containing information such as an address of a home, and a picture of the home, referred to as a street bid or data file. The user can then direct that a post card or mail piece be mailed to the home. The data file can be illustrated by means of a map overlay with identifiers of each street bid. A user can then circle or place a boundary around the identifiers and a list of the homes and addresses will appear.

### BACKGROUND OF THE INVENTION

Currently, most home service businesses market themselves by making flyers, walking through neighborhoods, and pass out flyers. There is usually no ideal space to place the flyer, so they are usually rolled up and placed in a door handle, or between the door and a door frame. And in many instances left to blow in the wind. It is illegal to place flyers in mailboxes.

There is a need for a mobile app that can create a database containing homes and corresponding addresses, and allow people access to the database.

There is also a need for such a mobile app to direct that the house be mailed a mail piece or post card.

### REFERENCE NUMERALS LIST

10 present invention, system to create a database containing pictures and respective addresses
20 person A capturing image, person A taking a picture
30 person A sharing a photo
40 opting into market place
50 person B accessing photo
60 person B paying database owner
70 database owner paying A
80 person B paying A
90 prompting A to share photo
100 person A
110 person B
120 database owner
130 sending a card
140 accessing the market place or the database containing data files
150 user interface
160 earning money by sharing photo in market place
170 selecting from a list of pre-taken photos
180 street bidding
190 preparing a mailing
200 database
210 data file
220 prompting a geographic location
230 photo ranking system
240 marketplace
250 photo or image
260 mail piece or postcard
270 sharing a photo
280 user
290 designating an area step
300 informing a user that the area has been captured step
310 capturing a photo
320 bid record or street bid or data file
330 entering address and price step
340 designating a specific address step
350 directing a mailing or post card ordering process
360 payment system
370 picture taken identifier
380 picture available identifier
390 marketplace map overlay feature
400 street bidder map overlay feature
410 identifying current location
420 selecting service area
430 moving street bid from marketplace to user account
440 importing pre-taken photos from marketplace
450 list screen
460 registering
470 mobile app user interface
480 dashboard
490 user files
500 history
510 card tracking
520 map overlay
530 marketing plan
540 settings
550 creating a data file
560 creating a database of data files
570 homeowner
580 selecting a template for the postcard
590 identifier
600 step of circling identifiers
610 Log in
620 Add record
630 Printer API
640 home page
650 search bid and build mailing page
660 page or screen
670 electrical communication device
680 data
690 BLANK
700 post card report
710 transaction history report
720 company profile
730 user page
740 street bier admin page
750 mobile app
760 mobile app login
770 mobile app main screen
780 mobile app bid record system
790 mobile app database design
800 mobile app communication with web API
810 web application programming interface
820 data collector
830 client admins
840 street bidder admins
850 web dashboard
860 tag

### SUMMARY OF THE INVENTION

One aspect of the present invention is an application and method for creating and managing a database 10, comprising: a web application programming interface 810; a mobile app 750 operably connected to said web application programming interface 810; said web application programming interface 810 having a page to add bid record 620; said web application programming interface 810 having a means of directing a mailing 350; said web application programming interface 810 having a page to allow a user 280 to search bid records/build mailings 650; said mobile app 750 having a user 280 to enter a bid record 620; and said mobile app 750 having a layer for communication with the web application programming interface 800.

Another aspect of the present invention is an application and method for creating and managing a database 10, comprising: a web application programming interface 810; a mobile app 750 operably connected to said web application programming interface 810; said web application programming interface 810 having a page to add bid record 620; said web application programming interface 810 having a means of directing a mailing 350; said web application programming interface 810 having a page to allow a user 280 to search bid records/build mailings 650; said mobile app 750 having a user 280 to enter a bid record 620; said mobile app 750 having a layer for communication with the web application programming interface 800; and a database 200 in operable connection with at least one of either said web application programming interface 810 or said mobile app 750.

A third aspect of the present invention is a method of creating a database containing data files 560, comprising the steps of creating a data file (550) by capturing a photo 310 and entering an address and price that corresponds to said photo 330.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of one embodiment of the present invention showing a user interface;

FIG. 3 is a pictorial view of one embodiment of a map overlay of the present invention;

FIG. 4 is a pictorial view of one embodiment of another map overlay of the present invention;

FIG. 5 is another pictorial view of one embodiment of the present;

FIG. 6 is a schematic of a method of using the present invention;

FIG. 7 is a schematic of a method of using the present invention;

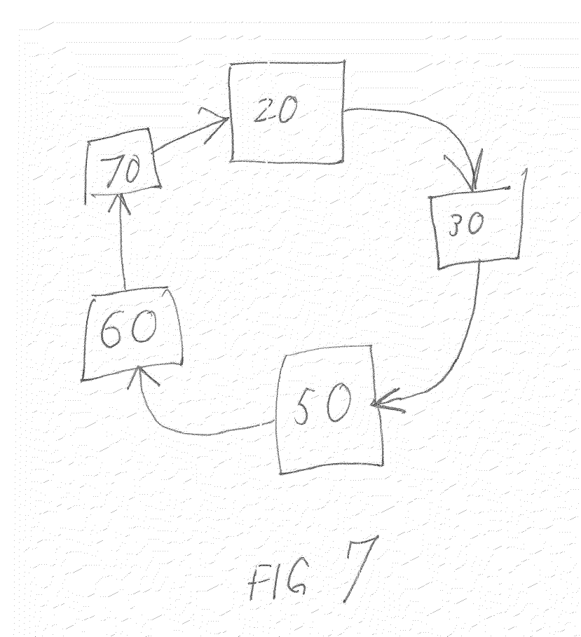

FIG. 8 is a pictorial of a your file tab;

FIG. 9 is a pictorial of a card tracking tab; and

FIG. 10 is a pictorial of a marketing plan tab.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

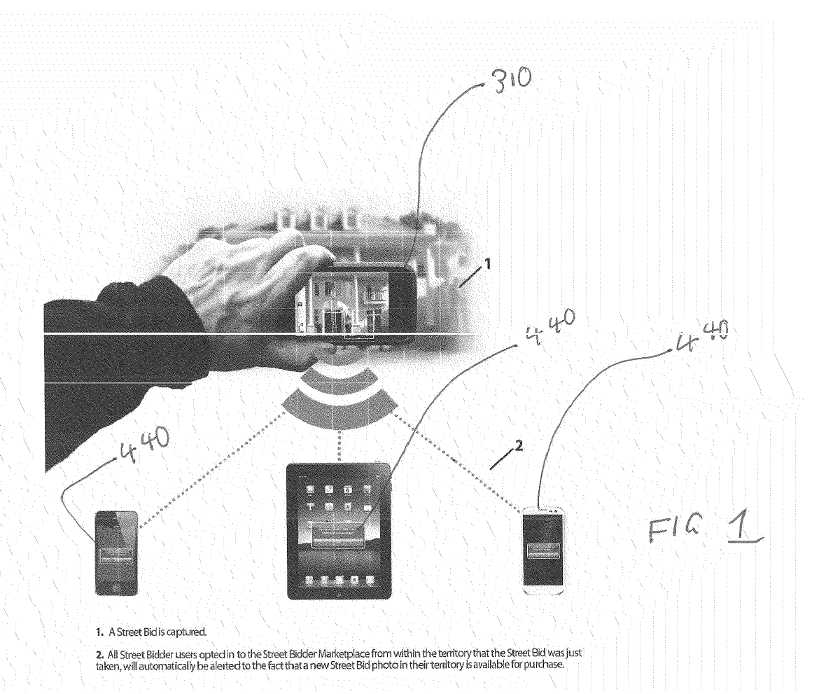

FIG. 1 illustrates the step of capturing a photo 310. this can be performed by using an electronic communication device 670, which includes but is not limited to a phone, tablet, or computer. After the photo is captured 310, then the app of the present invention 10 allows the user 280 to enter the address of the home or business in the step called entering address and price step 330.

In one embodiment there may be three types of users 280, data collectors 820, client admins 830, and street bidder admins 840. In one embodiment data collectors 820 may only use the mobile app 750 to submit a bid record 320, and data collectors do not access the web dashboard. In one embodiment the client admins 830 can access information for all clients. In one embodiment the street bidder admins 840 can access all information for clients.

In one embodiment, the bid record 320 may be a single address for which bid data 200 is collected.

In one embodiment of the present invention 10 is compatible with all web browsers or mobile app browsers. In another embodiment, the present invention 10 web application programming interface 810 is compatible with browsers including but not limited to Internet Explorer, Firefox, Chrome, and Safari.

Access to the present invention 10 will operate based on credits, which can either be purchased on demand or are applied to a subscriber's account each month based on successful payment and the user (280) service level.

In an alternative embodiment, the entering address and price step 330 occurs before the step of capturing a photo 310. The combination of the photo and respective address may be referred to as a street bid or data file 320. The user can then direct that a mailing or postcard 350 be mailed to the homeowner 570, and the mail piece or postcard 260 will have a picture of the homeowner's 570 house on the mail piece or postcard 260, and advertising the user's 280 business or services. This mail piece or postcard 260 is highly targeted and customizable via the features within the present invention 10.

This step is called the directing of a mailing step 350. This process of steps (1) capturing a photo 310; (2) entering address and price 330; (3) selecting a template 580; and (4) directing of a mailing 350 can be referred to herein as street bidding 180.

A user, referred to as person A, 100 of the present invention 10 may perform the person A sharing a photo 30 with any photo or image 250 they have taken by opting into marketplace 40. All photos taken by default may be owned solely by an entity called the database owner 120. When a user, such as person A, opts into the market place 40, the photos they have taken can now be used by others people, referred to as person B 110.

The original image capturer or picture taker, referred to as person A 100, may receive money if the image is placed in the market place 240 and used by another person, referred to herein as person B 110. The money may be paid from person B 110 to Person A 100, or person B 110 may pay the database owner 120, who then pays person A 100.

For example, a revenue share of 2 cents per used photo can be paid out to the original picture taker, person A, 100 and a charge of 5 cents per photo to the picture user, or person B 110.

When a user first downloads the present invention 10 they can start sending cards 130 right away simply by accessing the market place 240. There is no need to go out and take your own pictures, when a user can simply access the market place 240 and select from a list of pre taken photos 170.

After the first picture is taken by person A 100, an immediate prompt should appear encouraging the user to share this photo out with the market place 240, this step is referred to as the prompting the user to share a photo 90 in the market place 240. When a user shares a photo into the market place, they may start earning money right away. This may be contemporaneous with the step of opting into the marketplace 180. Once they opt in one photo 250 they are opting in every photo they have ever taken, and ever will with in application of the present invention 10.

From that point on the user is opted in and should never see this prompt again. The pictures they take through the application should just be quietly adding themselves to the marketplace 240. The pictures that the user takes when the application is closed will not be added to the marketplace 240. The picture of the house with the house's respective address, price, and possibly other data or information will be saved in a database 200 owned by the database owner 120.

The database 200 may be accessible to the user 280 forever. In another alternative the street bid or data files 320 created by the user 280 may be available forever.

The picture of the house and the house's respective address is referred to herein as a data file 210. The data file 210 can comprise other item of information or data.

A map overlay 520 may be a pictorial representation containing a geographical representation of an area, such as a city, a particular street, or a particular neighborhood. The map overlay 520 may display all of the user's 280 street bid or data files 320 as an identifier 590. In one embodiment the identifier 590 may be a pictorial of a pin.

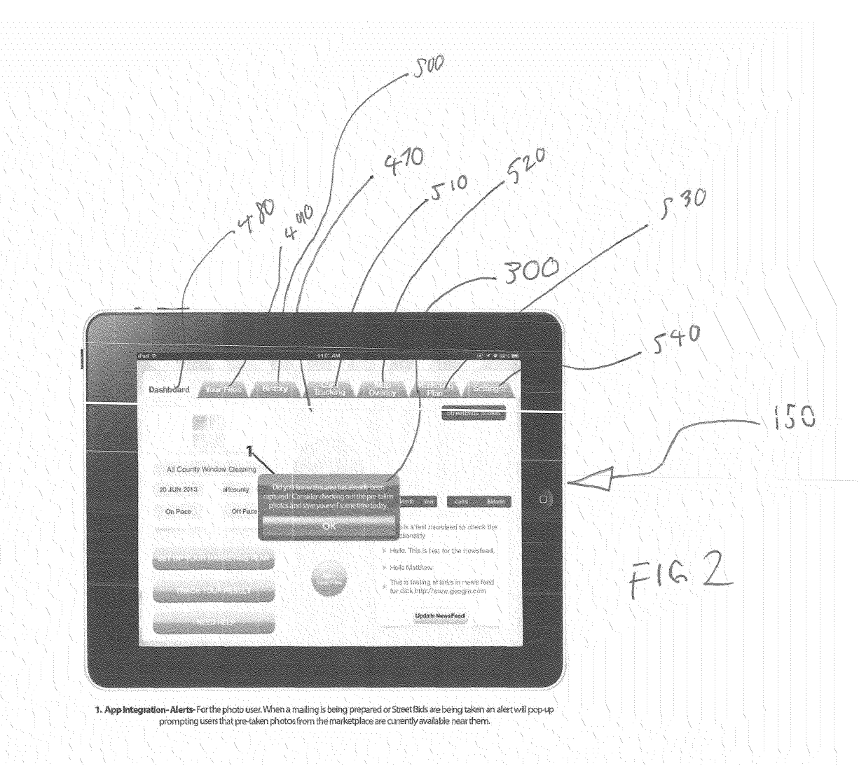

After opening the app, the user 280 will see the user interface 150, as illustrated in FIGS. 2, 3, and 4. The user interface 150 may include a web dashboard 850 when the interface 150 is displayed on a computer or web application programming interface 810. Then the user may click the map overlay 520 tab on the app, and a map appears of street bid or data files 320 that you have created. The user 280 can then place a circle or border or otherwise identify the addresses or areas that the user 280 wants to send mail pieces or postcards 260 to. The map overlay 520 may be used to pull a list screen 450 of data files 210.

When a mailing is being prepared 190 or when the user 280 selects, from the map overlay 520, or from a data file 210, or a plurality of data files 210, a series of prompts may occur encouraging users to:

Considering targeting of other areas within a certain radius where marketplace photos exist, referred to as the prompting by geographic location step 220.

Considering upgrading to a highly rated photos in place of their own. For example, there may be a photo ranking system 230. The photo ranking system 230 may consist of the marketplace 240 having every single property address in the United States there may be at a minimum 12 different photos taken from different angles at different times of day and year cataloged with in the marketplace 240.

This gives the end user the widest possible range of photos or images 250 to pick from to more closely match the product or service they offer with the correct photo or image 250 and mail piece or postcard 260.

For example, a person offering the service of a driveway re sealer may want a totally different angle then a window cleaner. In the spring season, the user may want to use a photo or image 250 taken in the spring. In the winter however a picture taken in the winter with snow on the ground may prove to be more effective.

If the user is sharing a photo 270 to the marketplace 240, the user 280 may be prompted with a message, “Did you know this area has already been captured? Consider checking out the pre taken photos and save yourself sometime today.” See FIG. 2. This may be referred to as the informing user that area has been captured step 300.

FIG. 2 also illustrates an embodiment of a user interface 150 of the present invention. In one embodiment the user interface 150 may have tabs for different windows. In one embodiment the user interface may have a dashboard 480, user files 490, history 500, card tracking 510, map overlay 520, marketing plan 530, and settings 540.

The dashboard 480 may have the capabilities to allow a user 280 to create new street bids or data files 320.

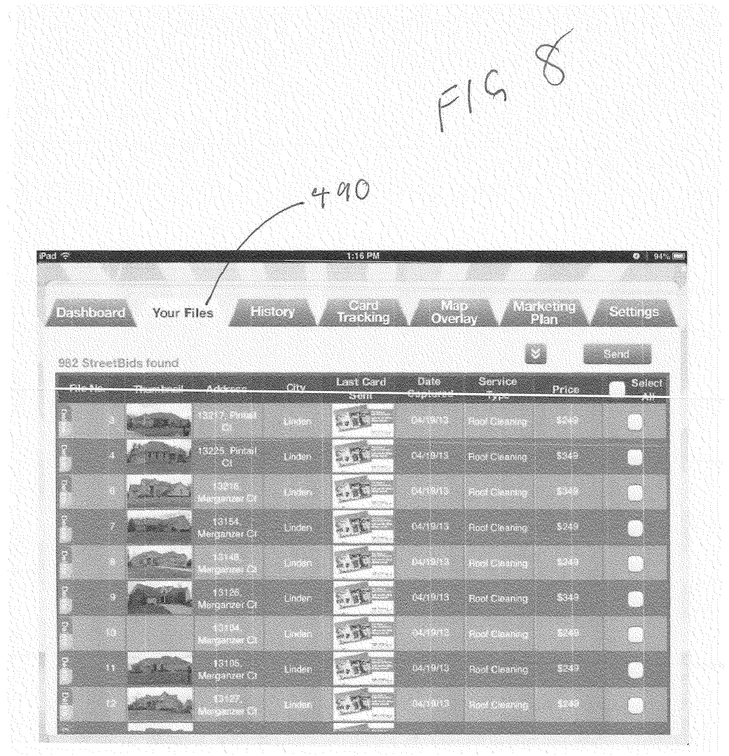

The user files 490 tab may have a file number, thumbnail of the picture of the house, address, picture of the last card sent, date captured, service type, and price, as seen in FIG. 8.

The history 500 tab may have a history of your street bids, purchases, and transactions.

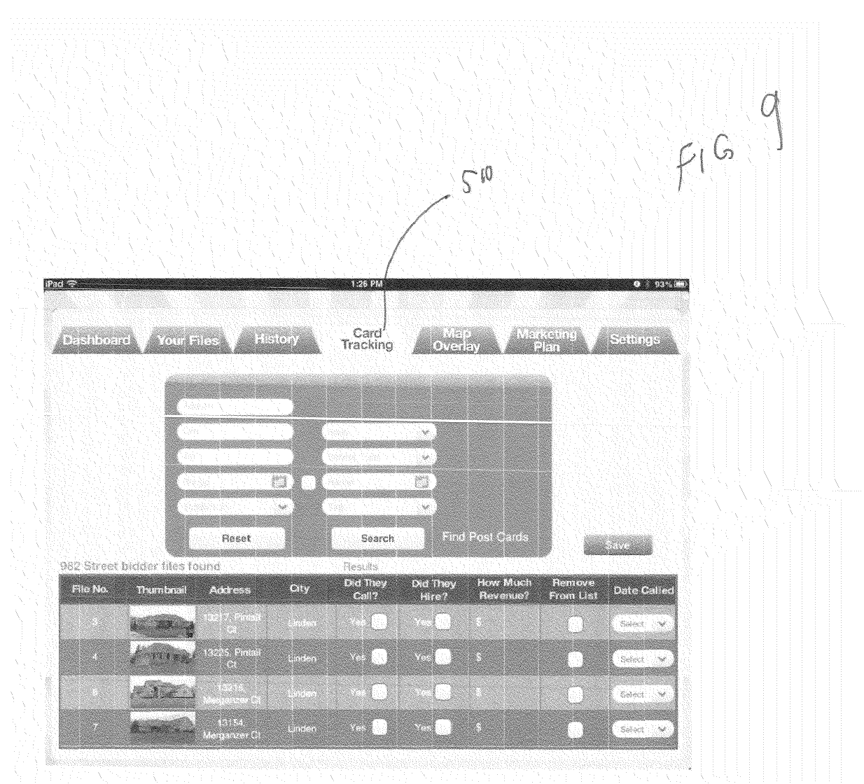

The card tracking 510 tab may have a file number, thumbnail, address, and then the user may input whether the homeowner 570 called, and if the homeowner 570 hired the user, the revenue, and date called, as seen in FIG. 9.

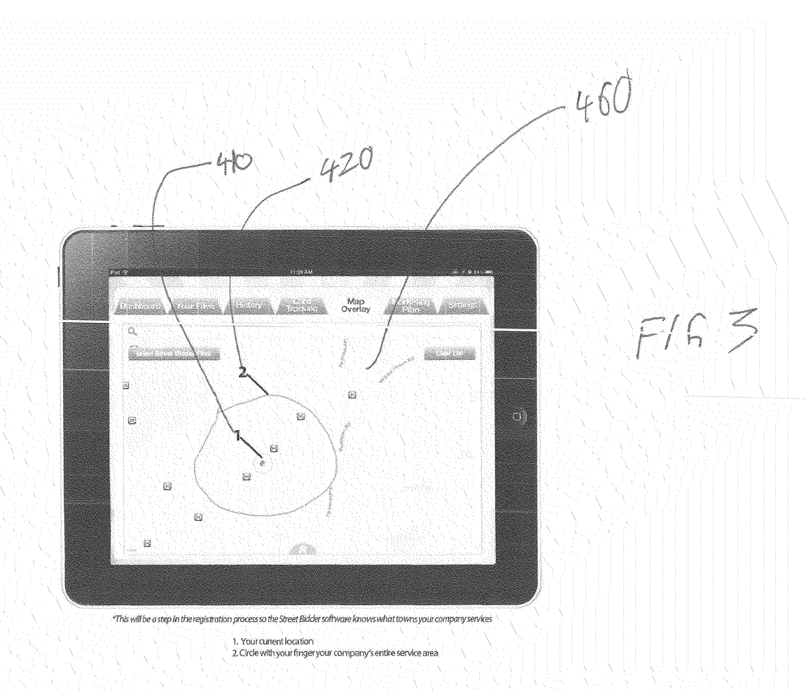

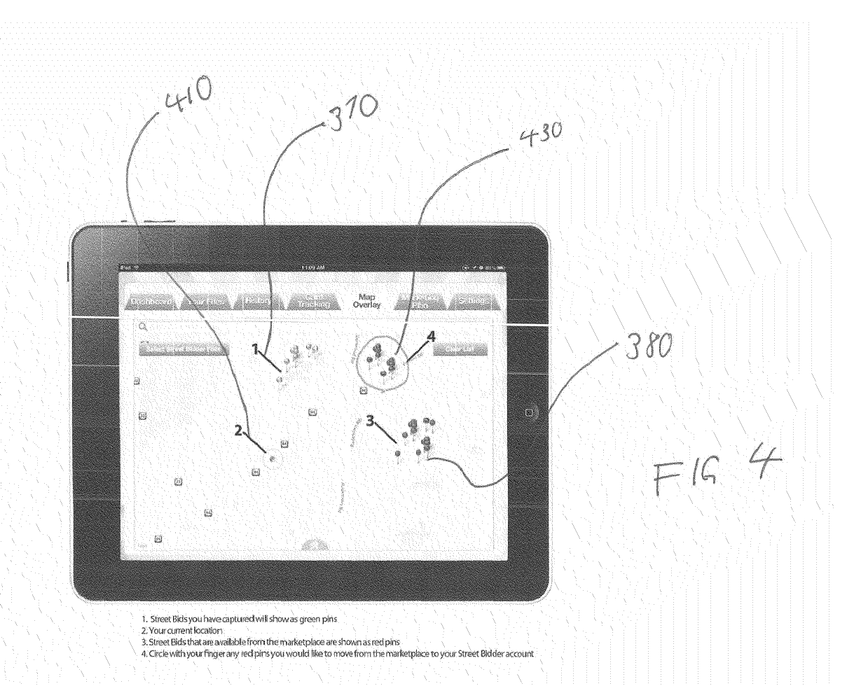

The map overlay 520 tab interface can be seen in FIGS. 3 and 4, and is discussed in more detail below.

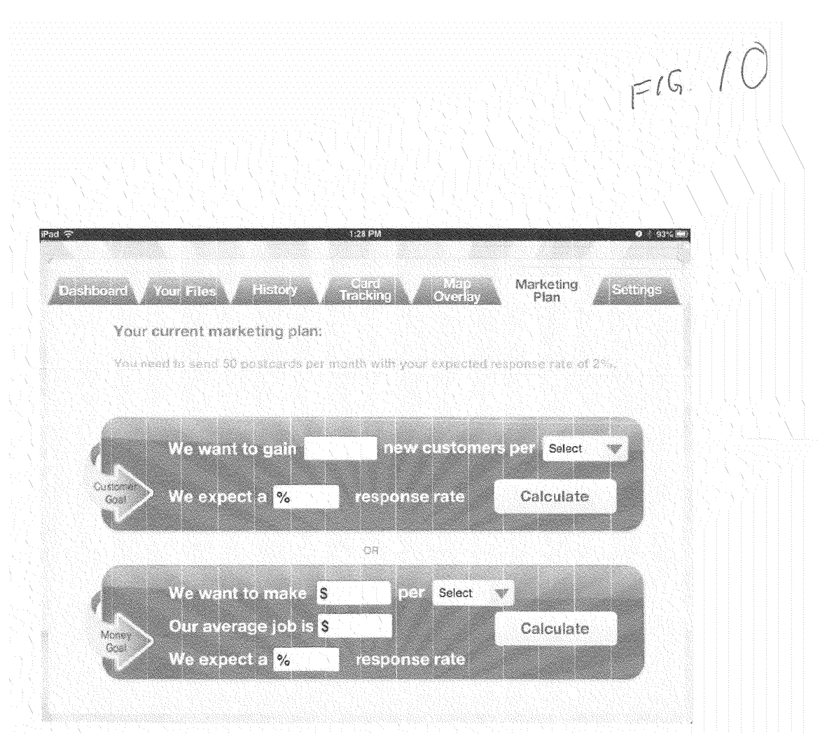

The marketing plan 530 tab may have two areas of entry. One for a goal on the number of customers, the other goal on income, as seen in FIG. 10. For the number of customer goal, the user may input the number of customers they want to gain per month, and input the expected response rate, and the app will indicate a recommended number of mail pieces or postcards 260 that should be mailed per time period. For the income goal, the user may input the desired dollars per time period, the average job fee, and response rate, and the app will indicate a recommended number of mail pieces or postcards 260 that should be mailed per time period.

FIG. 3 illustrates an embodiment of a identifying current location 410, and selecting service area 420. Identifying current location 410 may be performed by GPS, entering zip code, address, or touching your current location on a touch screen. Selecting service area 420 may be performed by GPS, entering a zip code, address, entering in a radius distance around your current location, or marking on a touchscreen.

The market place 240 should always be displayed in one tab within the app.

FIG. 4 illustrates an embodiment of the map overlay 520. After opening the map overlay 520 tab, the user 280 will see a geographic map with streets, and bodies of water where the user 280 has a street bid or data file 320.

FIG. 4 also illustrates a map of the user's data files or street bidder files displayed as a pin, also referred to as an identifier 590. In one embodiment, a green pin displayed on a map of the mobile app alerts the user that they previously captured a street bid or data file 320. This previously captured data file 210 represented by a green pin may be referred to as a picture taken identifier 370.

After opening the map overlay 520 tab, the user 280 will see a geographic map with streets, and bodies of water where the user 280 has a street bid or data file 320. The user 280 can then draw a circle or border around any of the identifiers 590 and the app automatically generates a list of the residences selected. Then the user 280 can then complete the step of directing a mailing 350 to send a mail piece or postcard 260 to the desired home.

The map overlay 520 also allows a user 280 to see the parts of a town or city that where the user 280 has created street bid or data file 320, and the portions of the town or city that the user 280 has not yet targeted. Also, if the user 280 wants to send another mail piece or postcard 260 at a later date, the user 280 only has to select the previously captured street bid or data file 320, and then complete the step of directing of a mailing 350.

There may be an icon or graphic for identifying current location 410. A picture available identifier 380 may be displayed, such as a pin of another color indicating that market place photos are available in those locations. This informs the user of street bids that are available from the marketplace 240. The user 280 may also perform the step of moving street bids from the marketplace to the user's account 430 if the data files were not previously in the user's 280 account. This can be performed by placing a border or circle around the red pins, or the picture available identifier 380.

This way the user 280 can send targeted mail piece or postcard 260 from one mobile app, without having to go to the post office or mailbox.

Also, several different employees may create a street bid or data file 320 at different parts of a city. All of the data files 210 will be synced to a particular user's account, thus each different employees data files 210 will be stored on the same database 200.

The map overlay 520 also provides a bird's eye view of the areas that the user 280 has captured by creating a street bid or data file 320, and those area that the user 280 has not captured. Also, in an embodiment, the user 280 can send a second mail piece or postcard 260 advertising a separate service from a previously sent card by entering different data or modifying data in the data file 210.

Data files 210 may be replaced by taking a new picture or capturing a photo 310, and then re-entering the data such as address.

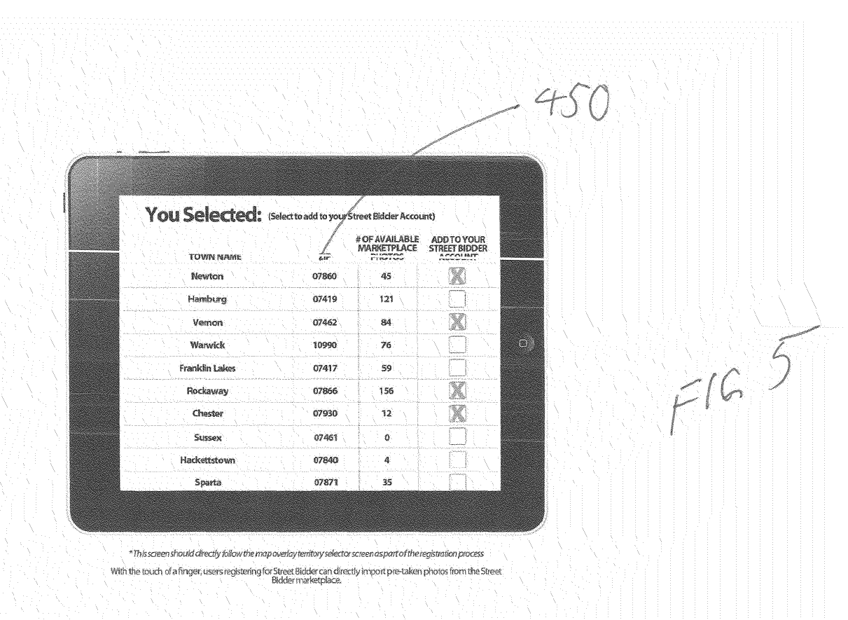

FIG. 5 illustrates the step of importing pre-taken photos from the marketplace 440. This can be done through a list screen 450, which can appear during registration. For example it can appear after the map overlay 520 screen is displayed during registration, or the step of registering 460.

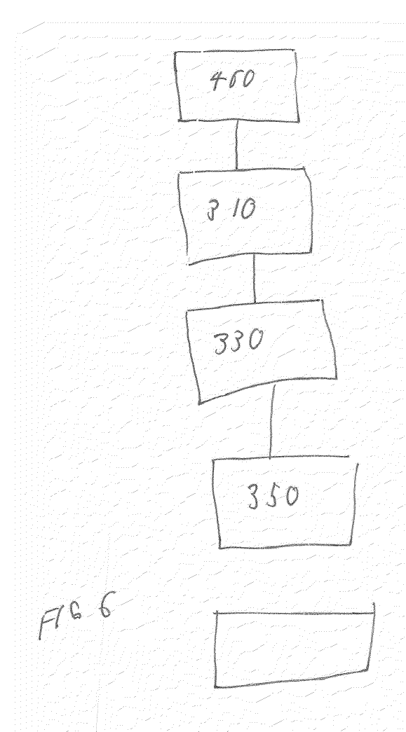

FIG. 6 illustrates one method of using the present invention. First is the step of registering 460, then capturing a photo 310, then entering an address and price step 330 of the home in the photo, selecting a template for the postcard 580, and lastly the step of directing a mailing 350 of a mail piece or postcard 260 having a photo or image 250 of the house to the desired address. Typically the homeowner should receive the mail piece or postcard 260 in about seven days.

The marketplace 240 will have a marketplace map overlay feature 390 that functions exactly like the street bidder map overlay feature 400 only it is completely pre populated with pins that when touched show photos already taken of the desired address by other street bidder users that have opted in to sharing their photos.

A user 280 will simply have to perform the designating an area step 290 they are interested in mailing to, or the designating a specific address step 340. This can be done by the user placing a circle, for example with a finger or stylus, around the area they are interested in mailing to or tap an individual pin. The circling of an area is called the designating an area step 290. Tapping a pin is called the designating a specific address step 340.

Prior to mailing a user will have to input one by one or in batches the prices and selected services to be featured on the card.

The payment system 360 can be structured in different ways. For example, the street bidder market place payment system 360 can pay out system will function much like a traditional affiliate system. When a user chooses opting into the marketplace 180 there will be no option for sharing a photo 270 with the marketplace 240. One button will enable all the photos they have ever taken from inside street bidder. The photos will immediately populate on the map overlay 420 and current street bidders in that territory will immediately be notified that new photos are available for use inside their service area.

Part of the step of registering 460 process must include a choice of payout method, and payout frequency. Pay outs are available to be paid out 15 days after someone successfully pays for a market place picture and sends a card. In one embodiment no pay outs be issued until the market place user as accumulated at least $99 in earned funds. This process is called the payment step 360.

When a user 280 starts using the present invention 10 for the very first time a feature should be built in that requires them to highlight and circle there service area. This will immediately populate a list of zip codes that they service. This step is called selecting a service area 420. One method of selecting a service area 420 is to circle or place a border with a finger or stylus, around the identifier(s) 590 that you want to send a mail piece or postcard 260 to.

When someone choose opting into the marketplace 40 for the first time, all the registered Street Bid users whether they use the marketplace feature or not, should be immediately alerted via email and pop up alert on their device that: “New Street Bid marketplace Photos have just been added to your territory, check them out right now, and lets send some cards!” This step is referred to as the step of alerting of new marketplace photos 440.

An intelligent ranking system should will be built into the market place 240. For example, every time a photo or image 250 is used it will be tagged with a point, one point per use. The photos or images 250 will be displayed to potential market place end users in order top to bottom or left to right based upon what photos have the most points. The idea is to have the best photos or images 250 organically rise to the top of the pile. This step is called prioritizing photos.

There should also be a set of attributes a user 280 can filter by. For example, (1) what season the photo or image 250 was taken, (2) recently added, (3) lighting conditions, (4) homes that purchased the most or least services, or (5) average estimated home value.

The user 280 taking a photo or image 250 should be actively encouraged to self-tag photos as they are taken, but simple automatic ones can be put in place. For example, a date range will predetermine what season a photo is tagged with a tie into a program with a weather API could base lighting conditions off what the forecast of that zip code was that day.

The present invention 10 may also have a mobile app user interface 470. The mobile app user interface 470 should be developed for the sole purpose of photographing and sharing photos out to the market place 240. In another embodiment the mobile app user interface 470 may be able to be developed on top of an existing photos apps API. It 470 should have a number of filters and auto correction features, as well as the ability to upload multiple photos of a property.

The present invention 10 may also have a mobile app user interface 470. There should be a type of dashboard 480 for marketplace 240 users of both types.

For the user 280, a simple photo uploader will work. To improve photo quality and customer satisfaction, this may be a necessary feature if we want professional very high quality photos to be uploaded. This will enable real photographers to upload their photos and certainly accelerate getting every property in the United States documented and uploaded to the marketplace 240. It will also help with bulk photo tagging and correction.

The app offers the ability to create “sub users” 280′. This will allow you to have many different log-ins for the same master account. For example separate employees cam can add a “Tag” 860 to each file they capture . . . for instance a guy named Matthew could add the tag “matthew” to every file he creates . . . then when a customer calls in to schedule you simply verify which tag 860 captured the file.

In a further embodiment, a user 280 can allow a sub-user 280′ to capture a photo 310 and prevent them from performing the step of directing a mailing 350.

For the user 280, a dashboard 480 that can be used from a desktop computer or laptop will make life easier. It will enable them to more accurately price jobs and select photos. A clean crisp interface that can be used from any web enabled device will accelerate adoption and ensure the maximum amount of cards are being mailed.

The present invention 10 may include a web application programming interface (Web API) 810 that receives and sends data from each of the elements of the solution, and enforces business rules. For example, the mobile applications 750 will use this Web API 810 to send collected data 680 int the database 200. In one example of the present invention 10, the services may require the user 280 to be online.

Log in 610 Validates the user's login and password. Also ensures that their subscription is currently active, that their user account is active, and that they may use the app. Also returns current state information, including: (a) the current list of active services for their account along with the current pricing and description for each size. (b) Total bid records 320 stored for either the entire Client (if login is a Client admin) or the Data Collector. (c) Current notifications, if any, for the user. (d) List of available tags. (e) Amount of time user may use the app before they must log in again. This will default to 7 days, after which time the user will not be allowed to continue using the mobile app. Syncs will always validate the user's status before accepting data. A notification will be provided to users who have not created a new Bid record in 5 days, saying: “You haven't created any new Street Bid Records in 5 days, add 5 today and get 10 credits,” and this notification will be displayed in the Web User Portal only.

Bid Record 620—Adds a new Bid record, which is a combination of: Address—street number, name, street type (e.g. “Street”, “Avenue”), state, zip code. Also comprising a single, optional photo as well as tags. A list of services, with each containing: selected size, standard price for size as of last login, and custom price, if any. If a matching address record is found for the account, a parameter will determine which of the following will be done: (option 1) The Bid Record will not be allowed to import (option 2) It will be marked as a duplicate. A client Admin can then later choose to replace the existing record or ignore the new Bid Record 620.

Printer API 630 may be an Interface matching existing application for the printer to access data. This will provide the raw data to be produced, constrained to the requirements provided prior to launch by the printer for proper layout (e.g. service name length). The printer is responsible for all final printed output.

The user interface 150 may include a home screen 640. The home screen 640 may be created using Model-View-Controller (MVC) based web application and bootstrap Responsive Web Design (RWD) template, including icons and graphics.

The user interface 150 may also include a testimonials page, a packaging and pricing page, a training and videos page, a contact page, a purchase page, and login-forgot password page.

Another feature of the user interface 150 present invention may include a search bid records/build mailing page(s) 650. The user 280 may use these pages or screens 660 to manage bid records 620 and/or build a list of selected bid records 620 to order a mailing. The currently selected bid records 620 can be added to, or removed from the screen or page 660.

Bid records 620 may be shown in real time as the bid records 620 are uploaded from the electronic communication device 670. Bid records 620 may be downloaded in CSV format, which includes all data 680, except the image, services and pricing. Bid records 620 may be uploaded in a CSV format by downloading a template with the appropriate column number and order.

Adding and editing bid records 620 can be accomplished through a client administrator page 660 of the user interface 150.

The present invention 10 may allow for a postcard ordering process. This may allow a client administrator or higher to select a street bid 320, or bid record 620, and submit a mailing 350, also referred to as means of directing a mailing 350.

The present invention 10 may also be able to generate a postcards report 700. A postcards report 700 may display a summary and detail for the mail pieces or postcards 260 ordered, broken down by week, month, year, and lifetime.

The present invention may also include a transaction history report 710, and allows the user 280 to search transactions by date, amount or cost, state or user, and see transaction details.

Another user interface 150 may include a company profile 720 page or screen 660. This allows client administrators to modify company information, such as modify company information, change logo, add credits and modify services. If a user 280 changes membership level, the existing Zooz subscription may cancel, the present invention may calculate prorated amount paid based on previous subscription, apply to first month payment, and prompt user to pay the balance immediately for the first month. The user 280 may be a company or client administrator. The user may create a new subscription on the company profile page 720.

A user page 730 may allow a user 280, such as a client administrator to see a list of all users for a certain company; add and edit data collectors, and specify other client administrative information; make client administrators and or data collectors inactive, reset passwords and provide user 280 profile information.

The user interface 150 may also include a street bidder admin page 740. This allows street bidder admins only to upload, edit and search template images. Mailing piece or postcard 260 size may be limited by membership level. For example 5×8′ postcards may only be available to Platinum Members. Templates may be designated as accessible to all clients or users 280, or just certain clients or users 280. This street bidder admin page 740 may also allow for the street bidder admins 280 or a user 280 with the right credentials to view clients and summary information, and access the company profile to make administrative-level changes.

The present invention 10 may also allow data collectors using a mobile app 750 on a electronic communication device 670, such as an Android or Apple IOS mobile app devices 670 to collect and transmit data 680 to the Web API. The mobile app 750 may push data to the Web API 850 only, and do not pull, view or edit existing data 680.

An mobile electronic communication device 670 may have a mobile app 750 having a login screen 760 whereby users 280 will be required to begin using the mobile app 750 of the present invention 10 to be online. Users must be online to sync records. At that time, the status of their user account and that of their company will be verified If either are inactive, they will not be allowed to sync bid records 620.

An mobile electronic communication device 670 may have a mobile app 850 that has access to a street bid main screen to allow data collectors or users 280 to enter each bid record 620.

An mobile electronic communication device 670 may have a mobile app 850 that has a view bid records screen 780 that displays the bid records 620 that have not yet been synced to the Web API.

An mobile electronic communication device 670 may have a mobile app 850 having a database design feature 790 that designs and implementation of necessary structures for storing data on the device itself prior to sync

An mobile electronic communication device 670 may have a mobile app 850 that has a layer for communication 800 with the Web API 810.

I claim:

1. An application and method for creating and managing a database (10), comprising:
a web application programming interface (810);
a mobile app (750) operably connected to said web application programming interface (810);
said web application programming interface (810) having a page to add bid record (620);
said web application programming interface (810) having a means of directing a mailing (350);
said web application programming interface (810) having a page to allow a user (280) to search bid records/build mailings (650);
said mobile app (750) having a user (280) to enter a bid record (620); and
said mobile app (750) having a layer for communication with the web application programming interface (800).

2. An application and method for creating and managing a database (10), comprising:
a web application programming interface (810);
a mobile app (750) operably connected to said web application programming interface (810);
said web application programming interface (810) having a page to add bid record (620);
said web application programming interface (810) having a means of directing a mailing (350);
said web application programming interface (810) having a page to allow a user (280) to search bid records/build mailings (650);
said mobile app (750) having a user (280) to enter a bid record (620);
said mobile app (750) having a layer for communication with the web application programming interface (800); and
a database (200) in operable connection with at least one of either said web application programming interface (810) or said mobile app (750).

3. The apparatus of claim 1, further comprising:
said web application programming interface (810) having a login page (610) that returns current state information, whereby said current state information is total bid records 320 stored.

4. The apparatus of claim 1, further comprising: a user interface (150) having a map overlay (520).

5. The apparatus of claim 1, further comprising:
directing of a mailing (350).

6. The mobile app (750) of claim 1, further comprising the steps:
accessing said database containing data files (140).

7. A method of creating a database containing data files (560), comprising the steps of creating a data file (550) by capturing a photo (310) and entering an address and price that corresponds to said photo (330).

8. The method of claim 7, further comprising a step of circling identifiers (600) whereby said step of circling identifiers (600) generates a list of date files (210)

9. The method of claim 7, further comprising:
accessing said database containing data files (140).

10. The method of claim 7, further comprising:
the step of selecting a postcard template (580).

11. The apparatus of claim 1, further comprising:
said mobile app (750) displays the bid records (320) that have not yet been synced to the web application programming interface (810).

12. The apparatus of claim 1, further comprising:
a login screen (610) that lists available tags (860).
